(19) United States
(12) Patent Application Publication
(10) Pub. No.: US 2017/0032448 A1
(43) Pub. Date: Feb. 2, 2017

(54) ORDERING PROGRAM, ORDERING DEVICE, AND ORDERING METHOD

(71) Applicant: FUJITSU LIMITED, Kawasaki-shi (JP)

(72) Inventors: Masayuki Kitajima, Yokohama (JP); Tetsuji Ishikawa, Kawasaki (JP); Yasumasa Wakasugi, Kawasaki (JP); KATSUYOSHI KUGO, Kawasaki (JP)

(73) Assignee: FUJITSU LIMITED, Kawasaki-shi (JP)

(21) Appl. No.: 15/293,589

(22) Filed: Oct. 14, 2016

Related U.S. Application Data
(63) Continuation of application No. PCT/JP2014/064161, filed on May 28, 2014.

(51) Int. Cl. G06Q 30/06; G06F 17/30

(52) U.S. Cl. CPC G06Q 30/0633; G06F 17/30345

(57) ABSTRACT

A non-transitory computer-readable recording medium stores an ordering program that causes a computer to execute a process. The process includes determining whether an article is a chemical material by using slip issue data that is input when ordering the article; checking whether the slip issue data includes permission identification information indicating that the article has been allowed to be ordered, when the article is determined to be the chemical material; and making an approval request to approve of ordering the article according to a result of the checking of the slip issue data.

### CROSS-REFERENCE TO RELATED APPLICATION

This application is a U.S. continuation application filed under 35 USC 111(a) claiming benefit under 35 USC 120 and 365(c) of PCT Application PCT/JP2014/064161 filed on May 28, 2014, the entire contents of which are incorporated herein by reference.

### FIELD

The present invention is related to an ordering program, an ordering device, and an ordering method for ordering chemical materials.

### BACKGROUND

Conventionally, business institutions that handle chemical materials such as factories and research laboratories are required to satisfy purchase conditions when placing orders for chemical materials. The purchase conditions include arrangements relevant to the storage location of the chemical materials and the location of handling chemical materials.
Patent Document 1: International Publication No. WO2005/119384

However, when the person in charge of placing an order does not have the knowledge relevant to the purchase conditions, the person may order a chemical material, even though the purchase condition is not satisfied.

### SUMMARY

According to one embodiment, a non-transitory computer-readable recording medium stores an ordering program that causes a computer to execute a process, the process including determining whether an article is a chemical material by using slip issue data that is input when ordering the article; checking whether the slip issue data includes permission identification information indicating that the article has been allowed to be ordered, when the article is determined to be the chemical material; and making an approval request to approve of ordering the article according to a result of the checking of the slip issue data.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF DRAWINGS

FIG. 1 is a diagram illustrating an example of an ordering system according to a first embodiment;

FIG. 2 is a diagram illustrating an example of a hardware configuration of an ordering device;

FIG. 3 is a diagram illustrating an example of a chemical material determination database;

FIG. 4 is a diagram for describing an example of a permission ID check database;

FIG. 5 is a diagram for describing a functional configuration of the ordering device according to the first embodiment;

FIG. 6 is a diagram illustrating an example of an input screen for inputting slip issue data;

FIG. 7 is a flowchart for describing operations of the ordering device according to the first embodiment;

FIG. 8 is a flowchart for describing a process by a database updating unit according to the first embodiment;

FIG. 9 is a diagram for describing a functional configuration of the ordering device according to a second embodiment;

FIG. 10 is a flowchart for describing updating of a chemical material determination database according to the second embodiment;

FIGS. 11A and 11B are diagrams for describing a process by a learning process unit according to the second embodiment;

FIG. 12 is a flowchart for describing a process by a weighting unit in a case where an upper limit and a lower limit are set;

FIG. 13 is a diagram for describing a functional configuration of the ordering device according to a third embodiment;

FIG. 14 is a diagram illustrating an example of a combination pattern database;

FIG. 15 is a flowchart for describing a process by the learning process unit according to the third embodiment;

FIG. 16 is a diagram for describing the process by the learning process unit according to the third embodiment;

FIG. 17 is a diagram illustrating a first modified example of the ordering system; and

FIG. 18 is a diagram illustrating a second modified example of the ordering system.

### DESCRIPTION OF EMBODIMENTS

### First Embodiment

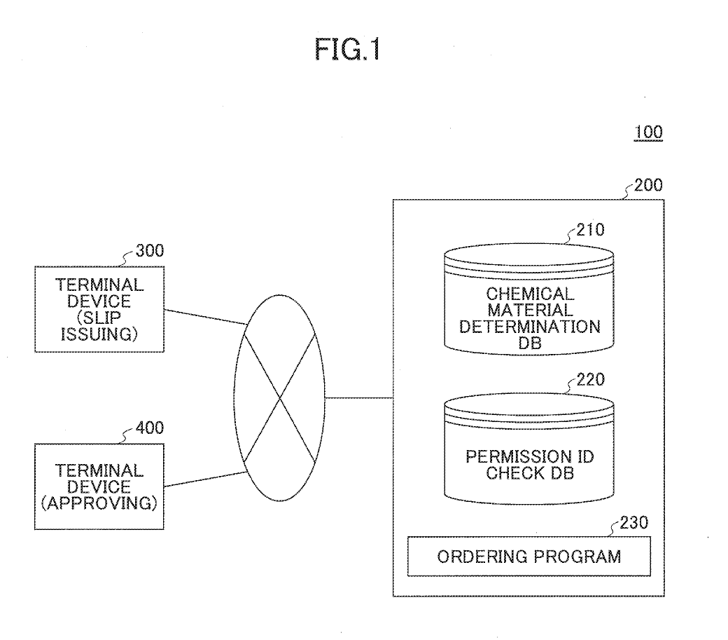

In the following, embodiments are described with reference to drawings. FIG. 1 is a diagram illustrating an example of an ordering system according to a first embodiment.

An ordering system 100 according to the present embodiment includes an ordering device 200 and terminal devices 300, 400. The ordering device 200 and the terminal devices 300, 400 according to the present embodiment are connected to each other via a network.

In the ordering system 100 according to the present embodiment, for example, when the ordering person issues an order slip for an article at the terminal device 300, the terminal device 300 sends the slip issue data input to the order slip, to the ordering device 200. When the ordering device 200 accepts the slip issue data to be input when purchasing the article, the ordering device 200 determines whether the ordered article is a chemical material and whether the purchase condition is satisfied, based on the slip issue data.

The purchase condition according to the present embodiment is a condition that is determined for each chemical material. For example, the purchase condition is a condition relevant to the storage and management of the chemical material and a condition relevant to the work environment of the location at which the chemical material is handled. Furthermore, in the following descriptions, an article that is scheduled to be ordered, for which the slip issue data has been input, is referred to as a purchase target article.

The ordering device 200 sends a request to approve of the order to the terminal device 400, when the purchase target article is a chemical material and the purchase condition is satisfied, or when the purchase target article is not a chemical material. For example, the terminal device 400 is a terminal used by an order approving person who is in charge of approving orders.

Furthermore, when the purchase target article is a chemical material but the purchase condition is not satisfied, the ordering device 200 sends a request to display an error message to the terminal device 300.

As described above, in the ordering system 100 according to the present embodiment, when it is determined that the purchase target article is a chemical material and the purchase condition is satisfied, a request is made to approve the order. Therefore, in the present embodiment, for example, the ordering person is caused to purchase a chemical material satisfying the purchase condition, regardless of whether the ordering person has the knowledge relevant to chemical materials and purchase conditions.

The ordering device 200 according to the present embodiment includes a chemical material determination database 210 and a permission ID check database 220. Furthermore, in the ordering device 200 according to the present embodiment, an ordering program 230 is installed.

The ordering device 200 according to the present embodiment executes the ordering program 230, and refers to the chemical material determination database 210 and the permission ID check database 220, to perform the process described below.

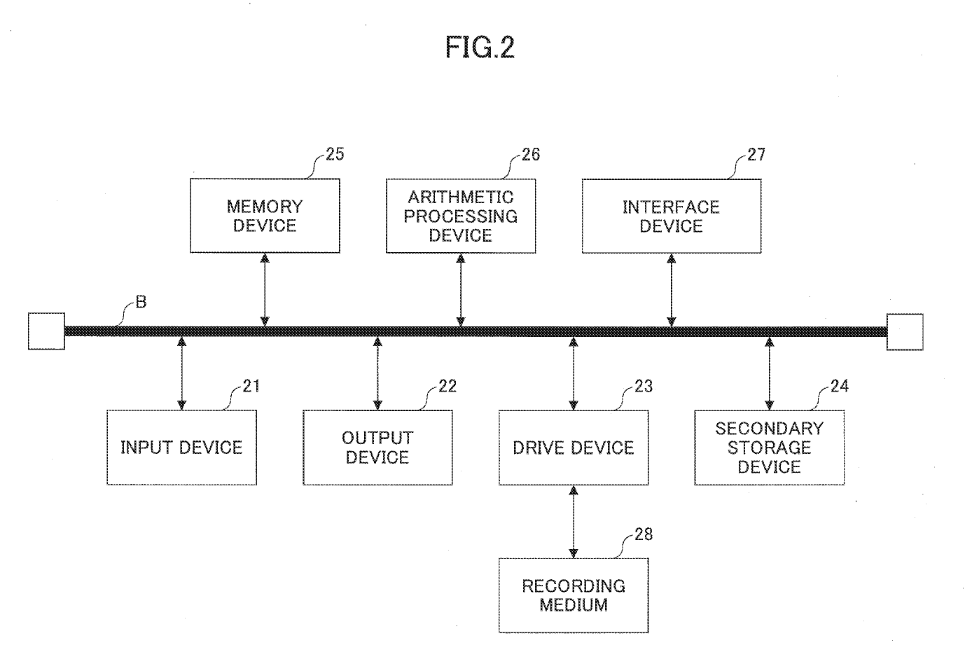

FIG. 2 is a diagram illustrating an example of a hardware configuration of the ordering device. The ordering device 200 according to the present embodiment includes an input device 21, an output device 22, a drive device 23, a secondary storage device 24, a memory device 25, an arithmetic processing device 26, and an interface device 27, which are connected to each other by a bus B.

The input device 21 includes a keyboard and a mouse, etc., and is used for inputting various signals. The output device 22 includes a display device, etc., and is used for displaying various windows and data, etc. The interface device 27 includes a modem and a LAN card, etc., and is used for connecting to a network.

The ordering program 230 is at least one of various programs for controlling the ordering device 200. The ordering program 230 is provided, for example, by being distributed in a recording medium 28 or by being downloaded from a network. As the recording medium 28 recording the ordering program 230, various types of recording media may be used, such as a recording medium for optically, electrically, or magnetically recording information including a CD-ROM, a flexible disk, and a magnetic optical disk, etc., or a semiconductor memory for electrically recording information such as a ROM and a flash memory, etc.

Furthermore, when the recording medium 28 recording the ordering program 230 is set in the drive device 23, the ordering program 230 is installed in the secondary storage device 24 from the recording medium 28 via the drive device 23. The ordering program 230 that has been downloaded from a network is installed in the secondary storage device 24 via the interface device 27.

The secondary storage device 24 stores the installed ordering program 230 and also stores files and data, etc., that are needed. The memory device 25 reads the ordering program 230 from the secondary storage device 24 when the computer is activated, and stores the ordering program 230. Furthermore, the arithmetic processing device 26 implements various processes as described below according to the ordering program that has been stored in the memory device 25.

Note that when the ordering device 200 according to the present embodiment is a tablet type computer, etc., the ordering device 200 may include a display operation device that serves as both the input device 21 and the output device 22. The display operation device is realized by a touch panel, etc., including a display function.

Furthermore, the terminal devices 300, 400 according to the present embodiment are, for example, a general computer or a tablet, etc., and the hardware configuration of the terminal devices 300, 400 is the same as that of the ordering device 200, and therefore the corresponding descriptions are omitted.

Next, a description is given of the databases included in the ordering device 200 according to the present embodiment.

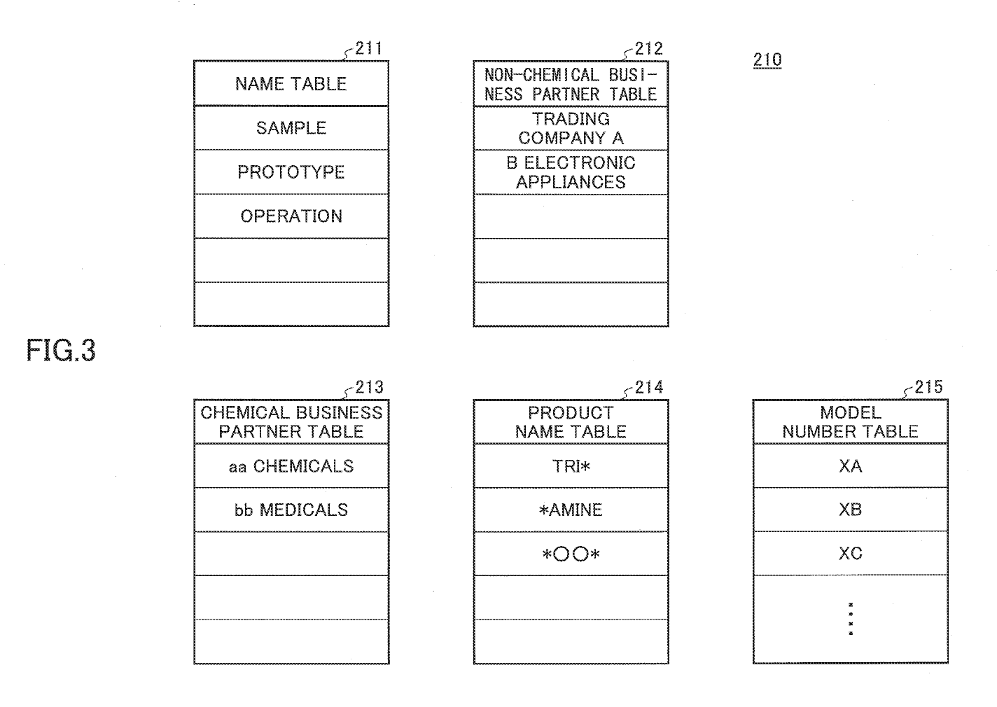

FIG. 3 is a diagram illustrating an example of the chemical material determination database. In the chemical material determination database 210 according to the present embodiment, a table is provided for each item of the chemical material determination database 210, and values of the item are stored in each table. The chemical material determination database 210 according to the present embodiment is referred to when determining whether the purchase target article is a chemical material.

The chemical material determination database 210 according to the present embodiment includes, as information items, a name, a non-chemical business partner, a chemical business partner, a product name, and a model number, and includes a name table 211, a non-chemical business partner table 212, a chemical business partner table 213, a product name table 214, and a model number table 215, corresponding to the respective items.

In the name table 211, words for determining that the purchase target article is a chemical material, are stored as values of the item “name”. That is, when a word of a purchase target article is a word that is stored in the name table 211, it may be determined that the corresponding purchase target article is not a chemical material. Specifically, examples of the words are “sample” and “operation”, etc. In the present embodiment, when the product name of the purchase target article included in the slip issue data includes a word that is stored in the name table 211, it is determined that the purchase target article is a non-chemical material. Note that a non-chemical material includes all articles that are not a chemical material.

In the non-chemical business partner table 212, names of business partners for determining that the purchase target article is a non-chemical material, are stored as values of the item “non-chemical business partner”. That is, the non-chemical business partner table 212 stores the names of the business partners that do not handle chemical materials. In the present embodiment, when the business partner included in the slip issue data is a business partner stored in the non-chemical business partner table 212, the purchase target article is determined to be a non-chemical material.

In the chemical business partner table 213, names of business partners for determining that the purchase target article is a chemical material, are stored as values of the item “chemical business partner”. That is, the chemical business partner table 213 stores names of business partners that handle chemical materials. In the present embodiment, when the business partner included in the slip issue data is a business partner stored in the chemical business partner table 213, the purchase target article is determined to be a chemical material.

In the product name table 214, product names or parts of product names for determining that the purchase target article is a chemical material, are stored as values of the item “product name”. In the present embodiment, when the product name of the purchase target article included in the slip issue data matches a product name or part of a product name stored in the product name table 214, the purchase target article is determined to be a chemical material. The product name stored in the product name table 214 according to the present embodiment may be, for example, a proper name of a chemical material. Furthermore, in a part of the product name stored in the product name table 214 according to the present embodiment, a wild card may be attached to a part of a proper name of the chemical material.

A wild card is a special character that matches any pattern when being searched. In the present embodiment, an asterisk (*) is used as a wild card. Specifically, the product name table 214 stores “tri*” and “*amin”, etc. Therefore, in the present embodiment, when “tri” or “amin”, etc., is included in the product name of the purchase target article included in the slip issue data, the purchase target article is determined to be a chemical material.

In the model number table 215, model numbers for determining that the purchase target article is a chemical material, are stored as values of the item “model number”. The model number table 215 according to the present embodiment stores model numbers of purchase target articles that have been determined to be chemical materials in the past. In the present embodiment, when the model number included in the slip issue data is a model number stored in the model number table 215, the purchase target article is determined to be a chemical material.

That is, the chemical material determination database 210 according to the present embodiment is a database storing keywords used for determining whether the purchase target article is a chemical material.

Note that the chemical material determination database 210 according to the present embodiment may be provided with tables corresponding to items included in the slip issue data other than the tables illustrated in FIG. 3. Specifically, for example, tables of a department code, a name of a person in charge, and a permission ID, etc., included in the slip issue data may be provided.

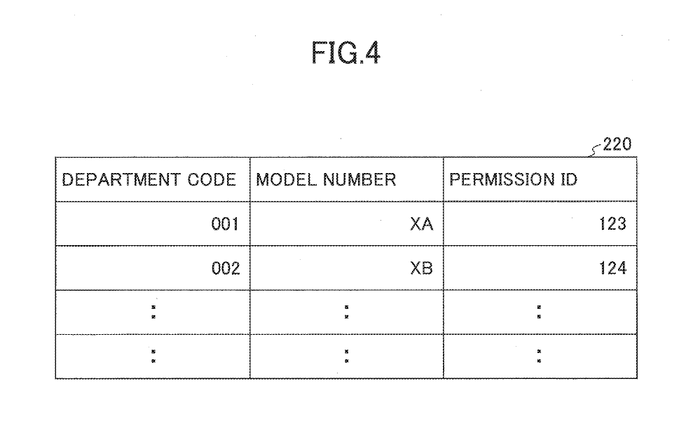

FIG. 4 is a diagram for describing an example of the permission ID check database.

The permission ID check database 220 according to the present embodiment is referred to when a purchase target article is determined to be a chemical material and when determining whether this purchase target article has already been approved to be ordered.

The permission ID check database 220 according to the present embodiment includes a department code, a model number, and a permission ID as items of information, and the items other than the department code are associated with the department code.

A department code, a model number, and a permission ID are items included in the slip issue data that is input when issuing an order slip.

The department code is a code for identifying the department to which the ordering person ordering a purchase target article belongs. The model number is identification information unique to the purchase target article identifying the purchase target article. The permission ID is identification information indicating that all of the purchase conditions required for ordering the purchase target article are satisfied. That is, a permission ID is permission identification information indicating that the ordering of the purchase target article is permitted.

The permission ID according to the present embodiment is issued in association with the department code and the model number, for example, by the order approving person, when the purchase target article is a chemical material and all of the purchase conditions are satisfied. The permission ID according to the present embodiment may be, for example, acquired by the ordering person by submitting an application to have a permission ID issued to the order approving person in advance.

In the present embodiment, when a permission ID is issued, the issued permission ID is stored in the permission ID check database 220 in association with the department code and the model number. Therefore, in the permission ID check database 220 according to the present embodiment, the model number of the chemical material for which all of the purchase conditions have been confirmed as being satisfied, is stored together with the department code and the permission ID.

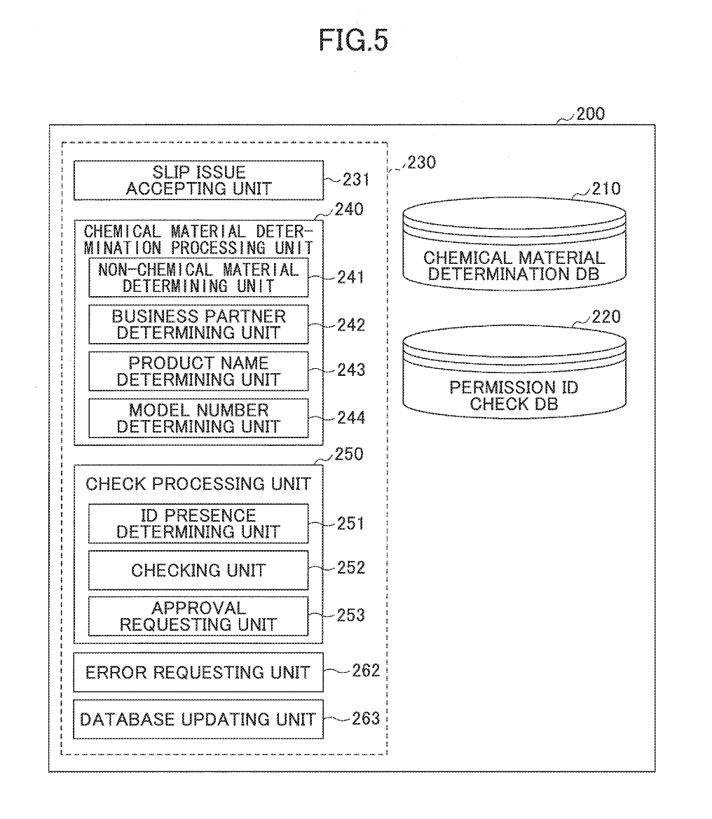

Next, referring to FIG. 5, a description is given of functions of the ordering device 200 according to the present embodiment. FIG. 5 is a diagram for describing the functional configuration of the ordering device according to the first embodiment.

In the ordering device 200 according to the present embodiment, the arithmetic processing device 26 executes the ordering program 230 to realize the processes of the respective units described below.

The ordering device 200 according to the present embodiment includes a slip issue accepting unit 231, a chemical material determination processing unit 240, a check processing unit 250, an approval requesting unit 253, an error requesting unit 262, and a database updating unit 263.

The slip issue accepting unit 231 according to the present embodiment accepts input of slip issue data from the terminal device 300. Note that the slip issue accepting unit 231 according to the present embodiment also accepts slip issue data input at the ordering device 200. Details of the slip issue data are described below.

The chemical material determination processing unit 240 refers to the chemical material determination database 210 and determines whether the purchase target article input in the slip issue data is a chemical material. Details of the chemical material determination processing unit 240 are described below.

The check processing unit 250 refers to the permission ID check database 220 when the purchase target article is determined to be a chemical material by the chemical material determination processing unit 240, and checks whether a permission ID is attached to the purchase target article. Details of the check processing unit 250 are described below.

When a permission ID is not attached to the purchase target article, the error requesting unit 262 requests the terminal device 300 to display an error message indicating that the purchase target article does not satisfy the purchase condition.

The database updating unit 263 updates the chemical material determination database 210. Details of processes by the database updating unit 263 are described below.

Next, a description is given of the chemical material determination processing unit 240. The chemical material determination processing unit 240 according to the present embodiment includes a non-chemical material determining unit 241, a business partner determining unit 242, a product name determining unit 243, and a model number determining unit 244.

The non-chemical material determining unit 241 according to the present embodiment refers to the name table 211 in the chemical material determination database 210, and determines whether the purchase target article is a non-chemical material. The business partner determining unit 242 refers to the non-chemical business partner table 212 and the chemical business partner table 213, and determines whether the purchase target article is a chemical material. The product name determining unit 243 refers to the product name table 214, and determines whether the purchase target article is a chemical material. The model number determining unit 244 refers to the model number table 215, and determines whether the purchase target article is a chemical material.

Next, a description is given of the check processing unit 250 according to the present embodiment. The check processing unit 250 according to the present embodiment includes an ID presence determining unit 251, a checking unit 252, and an approval requesting unit 253.

The ID presence determining unit 251 determines whether a permission ID is included in the slip issue data. The checking unit 252 refers to the permission ID check database 220 and checks whether the permission ID included in the slip issue data is correct, when the permission ID is included in the purchase target article. The approval requesting unit 253 requests the terminal device 400 to approve of the ordering of the purchase target article, when a permission ID is attached to the purchase target article.

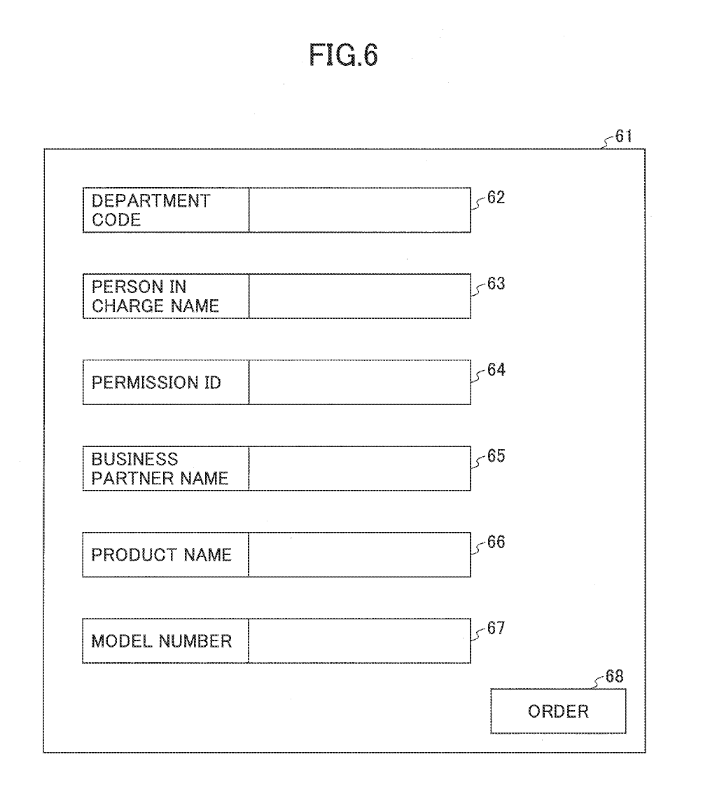

Next, a description is given of the slip issue data according to the present embodiment. FIG. 6 is a diagram illustrating an example of an input screen for inputting slip issue data.

An input screen 61 illustrated in FIG. 6 may be displayed, for example, on an output device, etc., of the terminal device 300 or may be displayed on an output device, etc., of the ordering device 200.

In the input screen 61 for inputting the slip issue data illustrated in FIG. 6, a department code input field 62, a person in charge name input field 63, a permission ID input field 64, a business partner name input field 65, a product name input field 66, a model number input field 67, and an order button 68, are displayed. In the input screen 61, for example, when information is input to the respective input fields 62 through 67 and the order button 68 is operated, the slip issue accepting unit 231 may accept the slip issue data.

In the present embodiment, the items included in the slip issue data are displayed as the respective input fields 62 through 67 displayed on the input screen 61. Therefore, in the case of FIG. 6, the department code, the name of the person in charge, the permission ID, the business partner name, the product name, and the model number are included as the items of the slip issue data.

Note that the slip issue data may also include, for example, a storage location of the purchase target article, an inspection location of the purchase target article, an order date, a delivery destination code, a cost bearing department code, a model number of the purchase target article, and a purchase quantity, etc., other than the items indicated in the input screen 61. Furthermore, the items and the values of items included in the slip issue data may be stored as tables in the chemical material determination database 210.

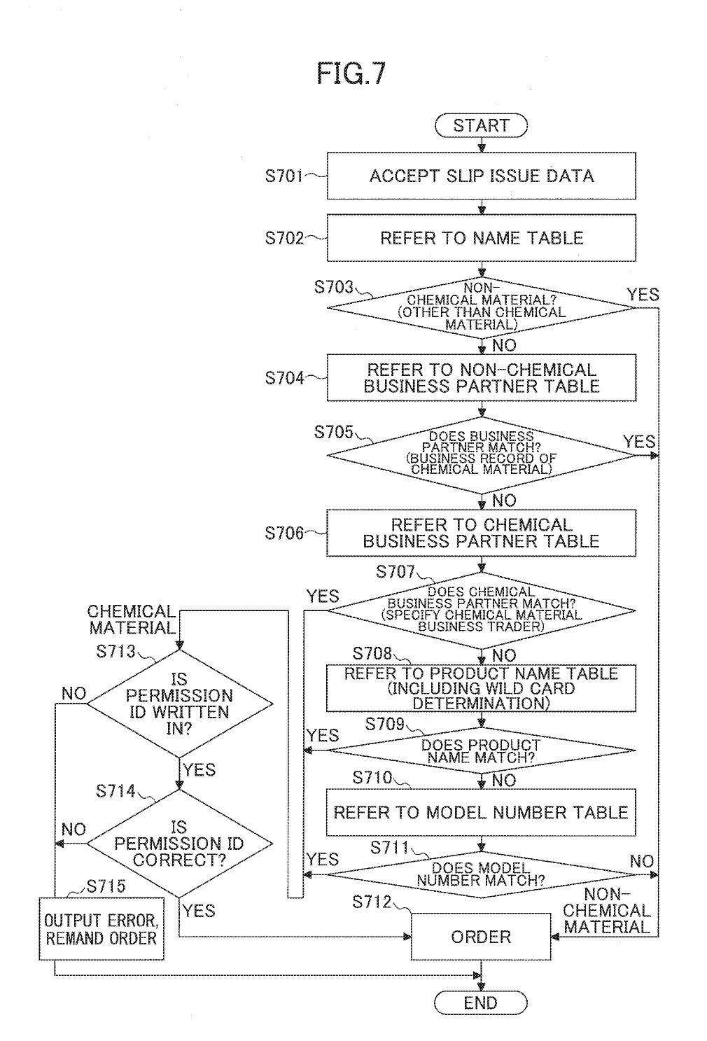

Next, referring to FIG. 7, a description is given of operations of the ordering device 200 according to the present embodiment. FIG. 7 is a flowchart for describing operations of the ordering device according to the first embodiment.

The ordering device 200 according to the present embodiment accepts slip issue data by the slip issue accepting unit 231 (step S701). Subsequently, the chemical material determination processing unit 240 determines whether the purchase target article is a non-chemical material, by the non-chemical material determining unit 241 (step S703). Specifically, the non-chemical material determining unit 241 refers to the name table 211 in the chemical material determination database 210 (step S702), and determines whether there is a word in the product name of the purchase target article included in the slip issue data, that matches a word in the name table 211.

In step S703, when there is a word that matches a word in the name table 211, the non-chemical material determining unit 241 determines that the purchase target article is a non-chemical material, and the non-chemical material determining unit 241 proceeds to step S712 described below.

In step S703, when there is no word that matches a word in the name table 211, the business partner determining unit 242 refers to the non-chemical business partner table 212 (step S704). Subsequently, the business partner determining unit 242 determines whether there is a business partner in the non-chemical business partner table 212 that matches the business partner of the purchase target article included in the slip issue data (step S705).

In step S705, when there is a corresponding business partner, the business partner determining unit 242 determines that the purchase target article is a non-chemical material, and the business partner determining unit 242 proceeds to step S712 described below.

In step S705, when there is no corresponding business partner, the business partner determining unit 242 refers to the chemical business partner table 213 (step S706). Subsequently, the business partner determining unit 242 determines whether there is a business partner in the chemical business partner table 213 that matches the business partner of the purchase target article included in the slip issue data (step S707).

In step S707, when there is a corresponding business partner in the chemical business partner table 213, the business partner determining unit 242 determines that the purchase target article is a chemical material, and the business partner determining unit 242 proceeds to step S713 described below.

In step S707, when there is no corresponding business partner in the chemical business partner table 213, the product name determining unit 243 refers to the product name table 214 (step S708). Subsequently, the product name determining unit 243 determines whether there is a product name in the product name table 214 that matches the product name of the purchase target article included in the slip issue data (step S709).

The product name determining unit 243 according to the present embodiment may determine that there is a matching product name, when there is a product name in the product name table 214 that matches the product name included in the slip issue data. Furthermore, the product name determining unit 243 according to the present embodiment may determine that there is a matching product name, when a part of the product name included in the slip issue data matches a part of a product name to which a wild card is attached.

In the following, the method of determining whether product names match by the product name determining unit 243 is further described.

Here, the product name included in the slip issue data is assumed to be “dimethylamine”. In this case, first, the product name determining unit 243 searches the product name table 214 by “dimethylamine”. Then, when “dimethylamine” is not found in the product name table 214, subsequently, the product name determining unit 243 searches “dimethylamine” by “tri*”. As a result of this search, “tri*” is not included in “dimethylamine”.

Subsequently, the product name determining unit 243 searches “dimethylamine” by “*amin”. As “dimethylamine” includes “*amin”, the product name determining unit 243 determines that “dimethylamine” is a chemical material.

As described above, in the present embodiment, by comparing a part of a product name including a wild card with the product name included in the slip issue data, it is possible to increase the probability that the purchase target article is determined to be a chemical material in step S709, and the load of processes in the subsequent stages may be alleviated.

In step S709, when there is a matching product name, the product name determining unit 243 determines that the purchase target article is a chemical material, and the product name determining unit 243 proceeds to step S713 described below.

In step S709, when there is no matching product name, the model number determining unit 244 refers to the model number table 215 (step S710). Subsequently, the model number determining unit 244 determines whether there is a model number in the model number table 215 that matches the model number included in the slip issue data (step S711).

In step S711, when there is a corresponding model number, the model number determining unit 244 determines that the purchase target article is a chemical material, and the model number determining unit 244 proceeds to step S713 described below.

In step S711, when there is no corresponding model number, the model number determining unit 244 determines that the purchase target article is a non-chemical material.

When the purchase target article is determined to be a non-chemical material, the ordering device 200 requests the terminal device 400 to approve of the ordering, by the approval requesting unit 253 (step S712), and ends the process.

Furthermore, when the purchase target article is determined to be a chemical material, the ordering device 200 determines whether a permission ID is included in the slip issue data, by the ID presence determining unit 251 of the check processing unit 250 (step S713). That is, the ID presence determining unit 251 determines whether the permission ID has been input to the input screen 61 for inputting the slip issue data.

In step S713, when the ID presence determining unit 251 determines that the permission ID is not included in the slip issue data, the ID presence determining unit 251 proceeds to step S715 described below.

In step S713, when the ID presence determining unit 251 determines that the permission ID is included in the slip issue data, the check processing unit 250 determines whether there is a permission ID in the permission ID check database 220 that matches the permission ID included in the slip issue data, by the checking unit 252 (step S714).

In step S714, when there is a matching permission ID, it is determined that the purchase target article is a chemical material and that all of the purchase conditions are satisfied, and the process proceeds to step S712.

In step S714, when there is no matching permission ID, it means that the purchase target article is determined to be a chemical material but the purchase conditions are not satisfied. Thus, the ordering device 200 makes request to display an error message indicating that the requirements needed for ordering the chemical material are not satisfied, by the error requesting unit 262 (step S715), and ends the process. Note that the request to display an error message is sent to the device that has displayed the input screen 61.

As described above, in the present embodiment, it is determined whether a purchase target article is a chemical material based on input slip issue data, and when the purchase target article is determined to be a chemical material, it is determined whether the chemical material satisfies the purchase conditions. Therefore, according to the present embodiment, the ordering person inputting the slip issue data is caused to purchase a chemical material satisfying the purchase condition, regardless of whether the ordering person has the knowledge relevant to chemical materials.

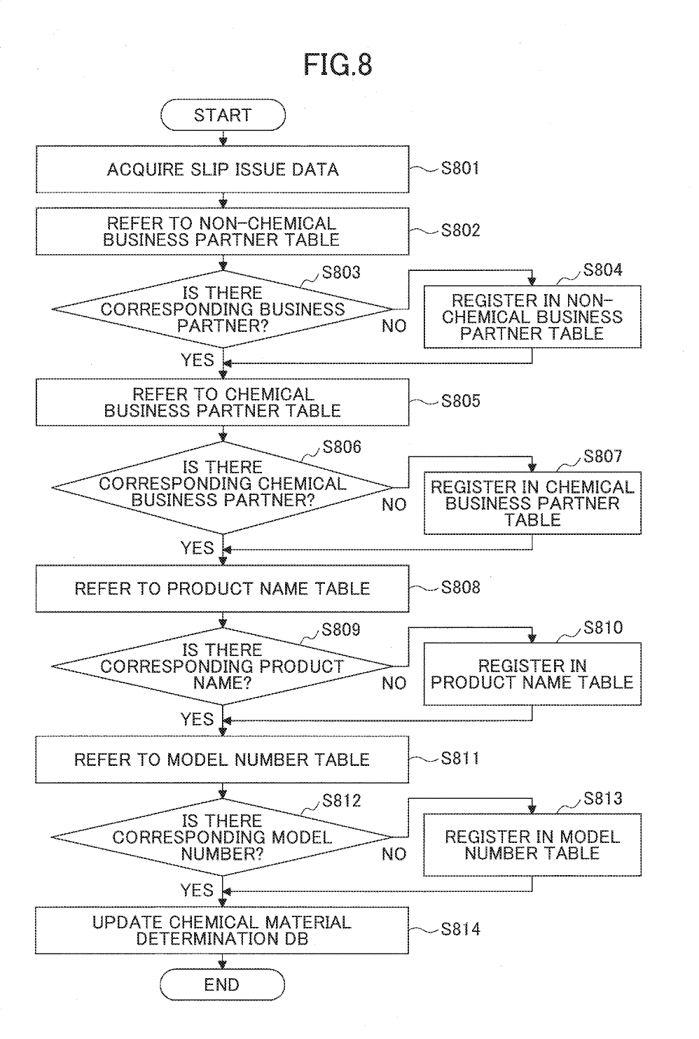

Next, referring to FIG. 8, a description is given of updating the chemical material determination database 210 by the database updating unit 263 of the ordering device 200.

The ordering device 200 according to the present embodiment determines whether a value of an item included in the slip issue data is stored in the chemical material determination database 210 by the respective units of the chemical material determination processing unit 240, and updates the chemical material determination database 210 according to the determination result. In the present embodiment, the slip issue data used for updating the chemical material determination database 210 is the slip issue data of the purchase target article that is determined to be a chemical material.

Note that in the present embodiment, for example, the name table 211 is assumed to be registered in advance by an administrator, etc., of the ordering system 100, and therefore the name table 211 is excluded from the targets of being updated by the database updating unit 263.

FIG. 8 is a flowchart for describing a process by the database updating unit according to the first embodiment.

The ordering device 200 according to the present embodiment acquires, by the database updating unit 263, the slip issue data accepted by the slip issue accepting unit 231 (step S801). Note that the slip issue data acquired here is slip issue data of the purchase target article that has been determined to be a chemical material.

Subsequently, the business partner determining unit 242 refers to the non-chemical business partner table 212 (step S802), and determines whether there is a business partner in the non-chemical business partner table 212 that matches the business partner of the purchase target article included in the slip issue data (step S803).

In step S803, when there is a corresponding business partner, the process proceeds to step S805 described below. In step S803, when there is no corresponding business partner, the database updating unit 263 registers the business partner name included in the slip issue data, in the non-chemical business partner table 212 (step S804).

Subsequently, the business partner determining unit 242 refers to the chemical business partner table 213 (step S805), and determines whether there is a business partner in the chemical business partner table 213 that matches the business partner of the purchase target article included in the slip issue data (step S806).

In step S806, when there is a corresponding business partner, the process proceeds to step S808 described below. In step S806, when there is no corresponding business partner, the database updating unit 263 registers the business partner name included in the slip issue data, in the chemical business partner table 213 (step S807).

Subsequently, the product name determining unit 243 refers to the product name table 214 (step S808), and determines whether there is a product name in the product name table 214 that matches the product name of the purchase target article included in the slip issue data (step S809).

In step S809, when there is a corresponding product name, the process proceeds to step S811 described below. In step S809, when there is no corresponding product name, the database updating unit 263 registers the product name included in the slip issue data, in the product name table 214 (step S810).

Subsequently, the model number determining unit 244 refers to the model number table 215 (step S811), and determines whether there is a model number in the model number table 215 that matches the model number of the purchase target article included in the slip issue data (step S812).

In step S812, when there is a corresponding model number, the process proceeds to step S814 described below. In step S812, when there is no corresponding model number, the database updating unit 263 registers the model number included in the slip issue data, in the model number table 215 (step S813).

Subsequently, the database updating unit 263 applies the information registered in the respective tables, to the chemical material determination database 210, and updates the chemical material determination database 210 (step S814), and ends the process.

As described above, in the present embodiment, the chemical material determination database 210 is updated based on the slip issue data of the purchase target article that has been determined to be a chemical material. Accordingly, it is possible to increase the precision in future processes of determining whether a purchase target article is a chemical material, performed by the chemical material determination processing unit 240.

### Second Embodiment

In the following, a description is given of a second embodiment with reference to drawings. The second embodiment is different from the first embodiment in that the chemical material determination database 210 is updated according to a result obtained by weighting each item included in the slip issue data. Thus, in the following description of the second embodiment, only the points that are different from the first embodiment are described, and the same reference numerals are applied to functional elements that are the same as those of the first embodiment, and the corresponding descriptions are omitted.

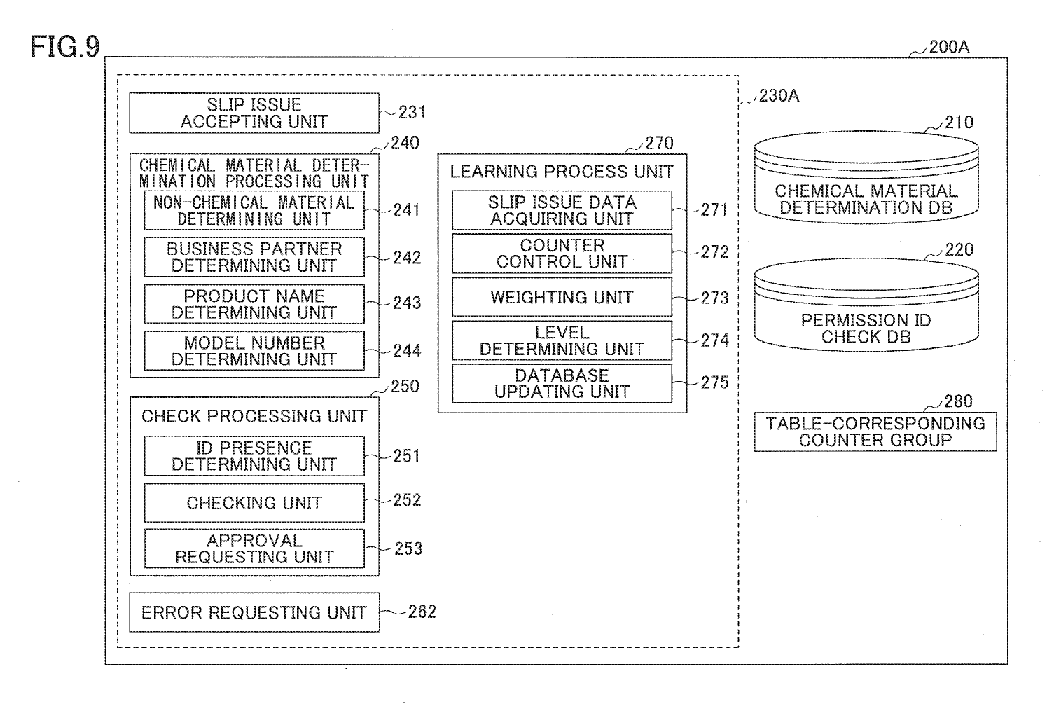

FIG. 9 is a diagram for describing the functional configuration of the ordering device according to the second embodiment. In an ordering device 200A according to the present embodiment, an ordering program 230A is installed.

Furthermore, the ordering device 200A according to the present embodiment includes a table-corresponding counter group 280 provided in the storage area of, for example, the memory device 25, etc.

The table-corresponding counter group 280 includes counters corresponding to the tables included in the chemical material determination database 210. Specifically, for example, the table-corresponding counter group 280 includes a non-chemical business partner counter corresponding to the non-chemical business partner table 212, and a chemical business partner counter corresponding to the chemical business partner table 213, etc. Furthermore, the table-corresponding counter group 280 includes a product name counter corresponding to the product name table 214, and a model number counter corresponding to the model number table 215, etc.

Furthermore, the ordering device 200A according to the present embodiment includes a learning process unit 270 instead of the database updating unit 263 of the first embodiment. The learning process unit 270 according to the present embodiment performs a learning process of updating the chemical material determination database 210 according to the slip issue data accepted by the slip issue accepting unit 231.

The learning process unit 270 according to the present embodiment includes a slip issue data acquiring unit 271, a counter control unit 272, a weighting unit 273, a level determining unit 274, and a database updating unit 275.

The slip issue data acquiring unit 271 acquires the slip issue data input to the input screen 61. The counter control unit 272 controls the values of the counters corresponding to the respective tables in the chemical material determination database 210, based on determination results obtained by the respective units in the chemical material determination processing unit 240.

The weighting unit 273 weights each item according to the value of the counter of each item in the table-corresponding counter group 280. The weight in the present embodiment is a value that is used as a reference for determining whether to add, to the chemical material determination database 210, a value of an item included in the slip issue data, as the value of the item in the chemical material determination database 210.

The level determining unit 274 determines whether to register a value of an item included in the slip issue data, to a corresponding table in the chemical material determination database 210. More specifically, the level determining unit 274 determines whether the weight of each item calculated by the weighting unit 273 has exceeded a predetermined threshold, and determines whether to update the corresponding table according to the result of determination.

The database updating unit 275 updates the chemical material determination database 210 according to the determination result by of the level determining unit 274.

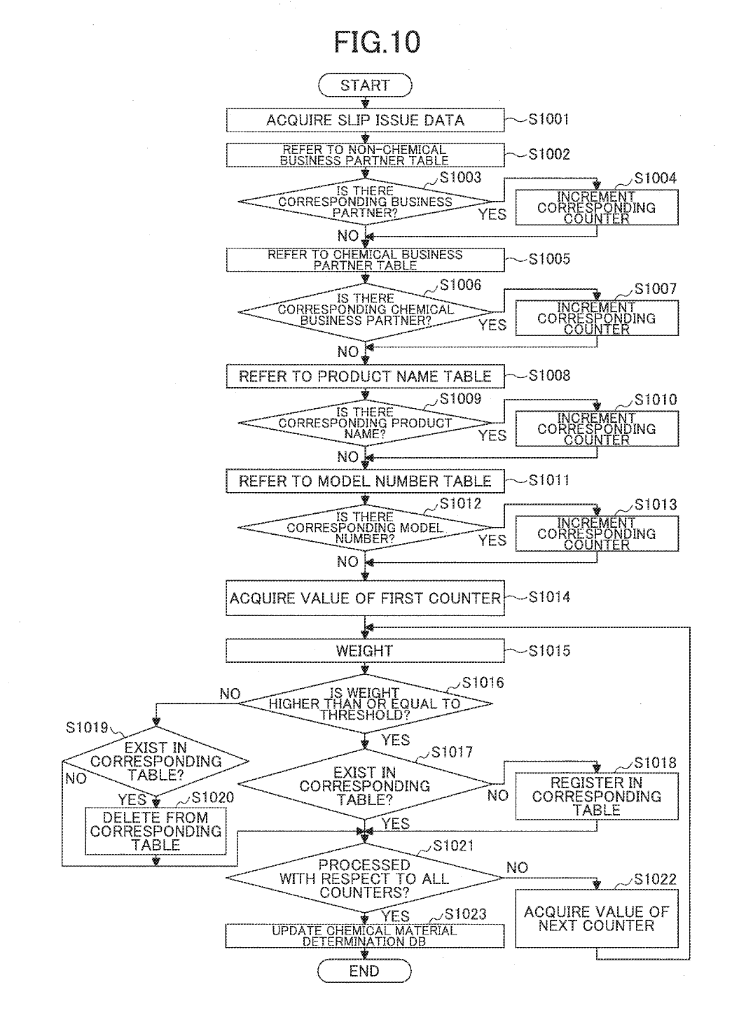

In the following, a description is given of the updating of the chemical material determination database 210 by the learning process unit 270 of the ordering device 200A according to the present embodiment. FIG. 10 is a flowchart for describing the updating of the chemical material determination database according to the second embodiment.

The slip issue data acquiring unit 271 according to the present embodiment acquires slip issue data accepted by the slip issue accepting unit 231 (step S1001). Furthermore, the slip issue data acquiring unit 271 according to the present embodiment holds the number of the acquired slip issue data items.

The processes of step S1002 and step S1003 of FIG. 10 are the same as the processes of step S802 and step S803 of FIG. 8, and therefore the corresponding descriptions are omitted.

In step S1003, when there is no corresponding business partner in the non-chemical business partner table 212, the process proceeds to step S1005 described below. In step S1003, when there is a corresponding business partner in the non-chemical business partner table 212, the counter control unit 272 increments the value of the non-chemical business partner counter (step S1004). Note that in the following description, the non-chemical business partner counter is described as the first counter.

The processes of step S1005 and step S1006 of FIG. 10 are the same as the processes of step S805 and step S806 of FIG. 8, and therefore the corresponding descriptions are omitted.

In step S1006, when there is no corresponding business partner in the chemical business partner table 213, the process proceeds to step S1008 described below. In step S1006, when there is a corresponding business partner in the chemical business partner table 213, the counter control unit 272 increments the value of the chemical business partner counter (step S1007). That is, in the present embodiment, the counter is counted up in order to hold information indicating that there is a corresponding business partner in the chemical business partner table 213.

The processes of step S1008 and step S1009 of FIG. 10 are the same as the processes of step S808 and step S809 of FIG. 8, and therefore the corresponding descriptions are omitted.

In step S1009, when there is no corresponding product name in the product name table 214, the process proceeds to step S1011 described below. In step S1009, when there is a corresponding product name in the product name table 214, the counter control unit 272 increments the value of the product name counter (step S1010).

The processes of step S1011 and step S1012 of FIG. 10 are the same as the processes of step S811 and step S812 of FIG. 8, and therefore the corresponding descriptions are omitted.

In step S1012, when there is no corresponding model number in the model number table 215, the process proceeds to step S1014 described below. In step S1012, when there is a corresponding model number in the model number table 215, the counter control unit 272 increments the value of the model number counter (step S1013).

The learning process unit 270 according to the present embodiment extracts the value of the first counter by the weighting unit 273 (step S1014).

Subsequently, the weighting unit 273 weights the acquired count value (step S1015). Details of the weighting by the weighting unit 273 in step S1015 are described below.

Subsequently, the learning process unit 270 determines whether the weight calculated in step S1015 is higher than or equal to a predetermined threshold, by the level determining unit 274 (step S1016). Note that the predetermined threshold may be set in advance.

In step S1016, when the weight is higher than or equal to the threshold, the database updating unit 275 determines whether the value of the item included in the slip issue data is included in the table corresponding to the counter from which the count value has been acquired (step S1017).

In step S1017, when the value of the item included in the slip issue data is not included the corresponding table, the database updating unit 275 registers the value of the item included in the slip issue data, in the corresponding table (step S1018). In step S1017, when the value of the item included in the slip issue data is included in the corresponding table, the learning process unit 270 proceeds to step S1021 described below.

In step S1016, when the weight is less than the threshold, the database updating unit 275 determines whether the value of the item included in the slip issue data is included in the corresponding table (step S1019). In step S1019, when the value of the item included in the slip issue data is included in the corresponding table, the database updating unit 275 deletes the value of the item included in the slip issue data, from the corresponding table (step S1020).

In step S1019, when the value of the item included in the slip issue data is not included in the corresponding table, the learning process unit 270 proceeds to step S1021 described below.

The database updating unit 275 determines whether the processes of steps S1015 and onward have been executed with respect to all of the counters (step S1021). In step S1021, when the processes have not been executed with respect to all of the counters, the database updating unit 275 acquires the value of the next counter (step S1022), and returns to step S1015.

In step S1021, when the processes have been executed with respect to all of the counters, the database updating unit 275 updates the chemical material determination database 210 (step S1023), and ends the process.

Note that in the present embodiment, the same threshold is used to determine whether to register or to delete a value of an item included in the slip issue data in or from the corresponding table in step S1016; however, the threshold is not so limited. In the present embodiment, for example, a threshold used for determining whether to register a value of an item included in the slip issue data in the corresponding table, and a threshold used for determining whether to delete a value of an item included in the slip issue data from the corresponding table, may be separately set.

In the following, a description is given of the calculation of the weight by the weighting unit 273 according to the present embodiment. The weighting unit 273 according to the present embodiment uses either one of the following to formulas to calculate the weight.

First, a description is given of formula (1). Formula (1) is indicated as follows.

Weight=initial fixed value×(α)^{n-x}×(1/β)^{x} formula (1)

Note that in formula (1), the initial fixed value is a value that is set in advance by an administrator, etc., of the ordering system 100. Furthermore, in formula (1), α, β are coefficients used for weighting, and these coefficients are values that are set in advance.

Furthermore, in formula (1), n is the number of slip issue data items accepted by the slip issue accepting unit 231, that is, the number of slip issue data items acquired by the slip issue data acquiring unit 271. Furthermore, in formula (1), x is the number of times that any of the counters have not been incremented in the processes of step S1004 through step S1014. Therefore, in the present embodiment, the value of n−x is the number of times that the counters have been incremented.

Next, a description is given of formula (2). Formula (2) is indicated as follows.

Weight=initial fixed value+n×α−(n−x)×β formula (2)

The weighting unit 273 according to the present embodiment may arbitrarily select either one of formula (1) or formula (2) described above, and weight the item. Note that in the present embodiment, when formula (2) is used, the item is largely affected by the weight in a case where the counter has not been incremented.

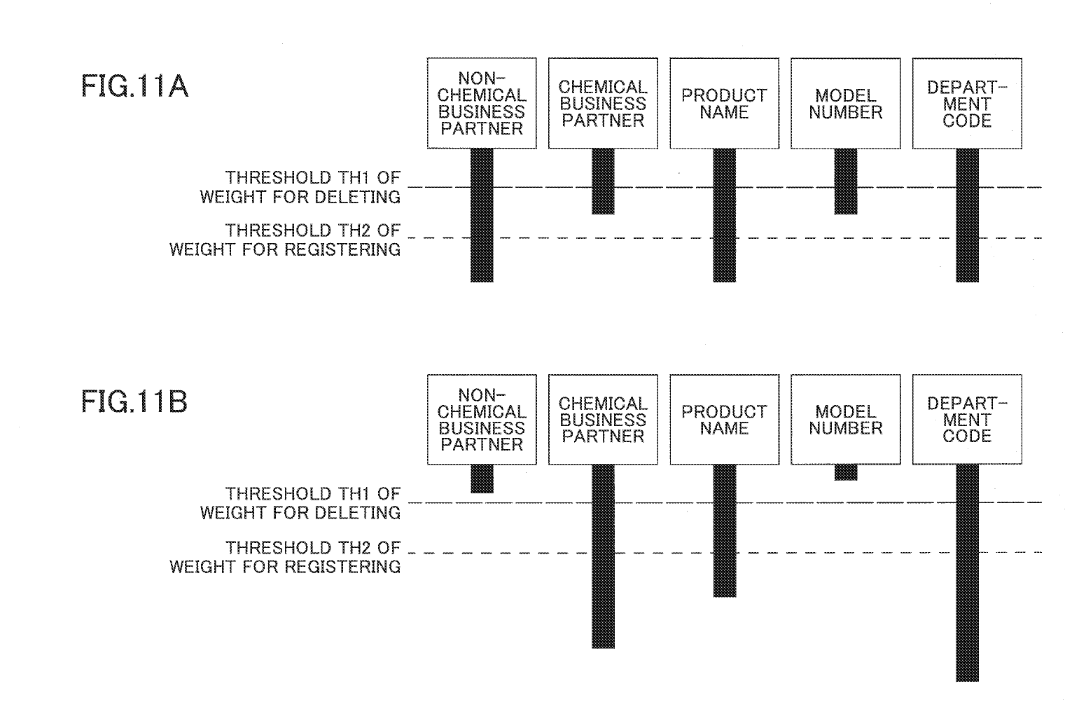

Next, referring to FIGS. 11A and 11B, a specific description is given of the process by the learning process unit 270 according to the present embodiment. FIGS. 11A and 11B are diagrams for describing a process by the learning process unit according to the second embodiment. FIG. 11A illustrates the weights corresponding to the respective tables in the chemical material determination database 210 calculated before acquiring the newest slip issue data, and FIG. 11B illustrates the weights corresponding to the respective tables in the chemical material determination database 210 calculated after acquiring the newest slip issue data. Furthermore, in the example of FIGS. 11A and 11B, the threshold used for determining to delete a value of an item from the table is TH1, and the threshold used for determining to register a value of an item to the table is TH2.

Referring to FIGS. 11A and 11B, a description is given of an example in which the business partner name included in the slip issue data is aa chemicals, the product name included in the slip issue data is dimethylamine, and the model number included in the slip issue data is XB.

In this case, in the processes from step S1002 through step S1011 of FIG. 10, the values of the chemical business partner counter corresponding to the chemical business partner table 213, the product name counter corresponding to the product name table 214, and the model number counter corresponding to the model number table 215 are respectively incremented.

Thus, for example, the learning process unit 270 acquires the value of the non-chemical business partner counter, as the value of the first counter, by the database updating unit 275. In the non-chemical business partner table 212, aa chemicals is not included, and therefore the value of the non-chemical business partner counter is not incremented here. Therefore, in formula (1) or formula (2), n that is the number of slip issue data items acquired by the slip issue data acquiring unit 271, and x that is the number of times that the counter has not been incremented, respectively become plus 1.

The weighting unit 273 uses these values of n and x to calculate the weight corresponding to the non-chemical business partner counter. In a case where the calculated weight is not higher than or equal to a threshold, when aa chemicals is included in the non-chemical business partner table 212, aa chemicals is deleted, and when aa chemicals is not included in the non-chemical business partner table 212, the value of the next counter is acquired.

Furthermore, in a case where the calculated weight is higher than or equal to a threshold, when aa chemicals is not included in the non-chemical business partner table 212, aa chemicals is registered in the non-chemical business partner table 212, and when aa chemicals is included in the non-chemical business partner table 212, the value of the next counter is acquired.

As described above, in the present embodiment, the tables included in the chemical material determination processing unit 240 are updated according to the content of the slip issue data.

For example, in FIG. 11A, the weight calculated from the value of the non-chemical business partner counter is higher than or equal to the threshold TH2. Therefore, in the example of FIG. 11A, aa chemicals is registered in the non-chemical business partner table 212. Similarly, in FIG. 11A, the weight calculated from the value of the product name counter is higher than or equal to the threshold TH2. Therefore, in the example of FIG. 11A, “dimethylamine” is registered in the product name table 214.

Furthermore, in FIG. 11A, the weight calculated from the value of the model number counter is less than the threshold TH2, but higher than or equal to the threshold TH1. Therefore, the model number XB is not deleted from the model number table 215.

Furthermore, in the example of FIG. 11B, the weight calculated from the value of the non-chemical business partner counter is less than the threshold TH1. Therefore, in the example of FIG. 11B, aa chemicals is deleted from the non-chemical business partner table 212. Furthermore, in FIG. 11B, the weight calculated from the value of the product name counter is higher than or equal to the threshold TH2. Therefore, “dimethylamine” is registered in the product name table 214.

Furthermore, in FIG. 11B, the weight calculated from the value of the model number counter is less than the threshold Ti. Therefore, the model number XB is deleted from the model number table 215.

As described above, in the present embodiment, every time the slip issue data is accepted, the learning process unit 270 learns the content of the slip issue data and updates the chemical material determination database 210 according to the content of the slip issue data. Therefore, in the present embodiment, it is possible to increase the precision in the process of determining whether a purchase target article is a chemical material based on the slip issue data.

Note that in the present embodiment, an upper limit and a lower limit may be set for the value of the weight. In the following, a description is given of a case where an upper limit and a lower limit are set for the value of the weight.

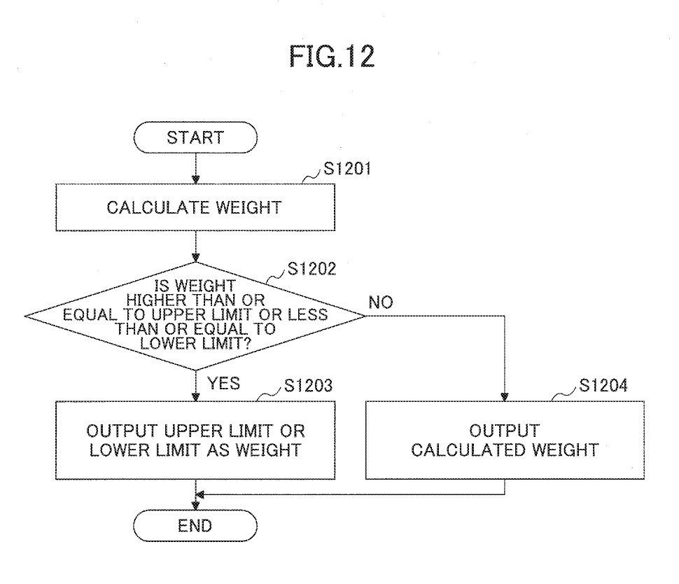

FIG. 12 is a flowchart for describing a process by the weighting unit in a case where an upper limit and a lower limit are set.

When the weighting unit 273 calculates a weight (step S1201), the weighting unit 273 determines whether the calculated weight is higher than or equal to an upper limit, or whether the calculated weight is less than or equal to a lower limit (step S1202).

In step S1202, when the weight is higher than or equal to an upper limit or less than or equal to a lower limit, the weighting unit 273 outputs the upper limit or the lower limit as the weight (step S1203). In step S1202, when the weight is not higher than or equal to an upper limit or less than or equal to a lower limit, the weighting unit 273 outputs the calculated weight (step S1204).

In the present embodiment, by setting an upper limit and a lower limit for the weight as described above, it is possible to avoid a situation where the weight deviates from the threshold every time a weight is calculated.

### Third Embodiment

In the following, a description is given of a third embodiment with reference to drawings. The third embodiment is different from the second embodiment in that the weight is calculated for each combination of items. Thus, in the following description of the third embodiment, only the points that are different from the second embodiment are described, and the same reference numerals are applied to functional elements that are the same as those of the second embodiment, and the corresponding descriptions are omitted.

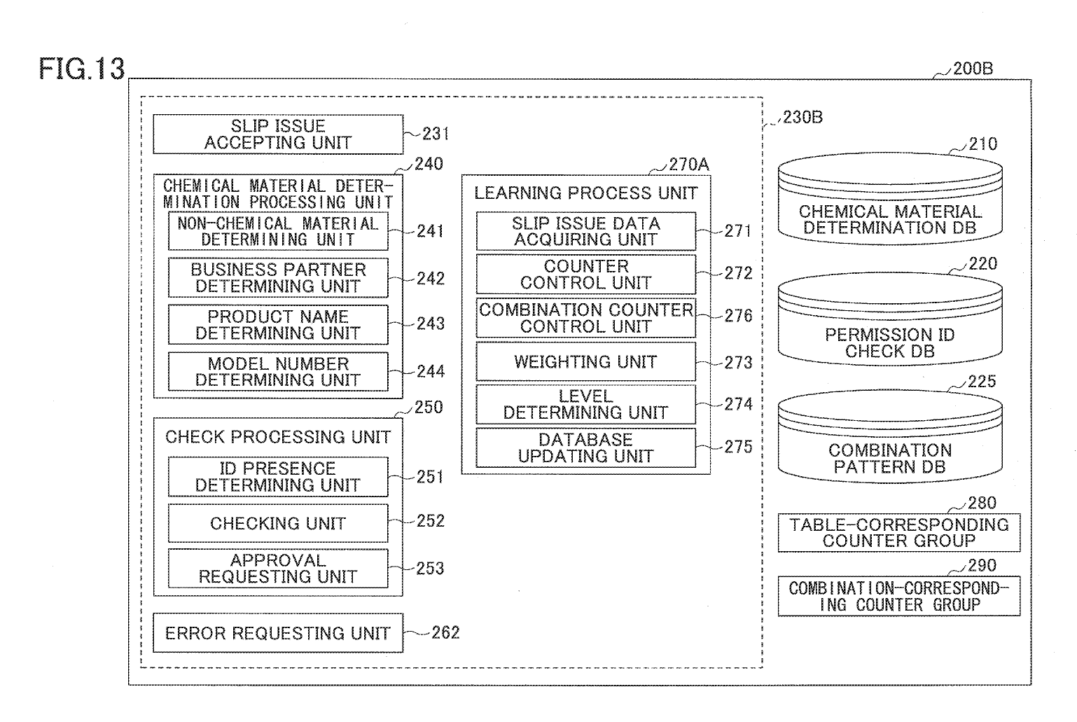

FIG. 13 is a diagram for describing the functional configuration of the ordering device according to the third embodiment. In an ordering device 200B according to the present embodiment, an ordering program 230B is installed.

The ordering device 200B according to the present embodiment includes a combination pattern database 225 and a combination-corresponding counter group 290.

In the combination pattern database 225, combinations of items included in the chemical material determination database 210 are stored.

The combination-corresponding counter group 290 is a group of counters including counters corresponding to the respective combinations stored in the combination pattern database 225.

Furthermore, the ordering device 200B according to the present embodiment includes a learning process unit 270A. The learning process unit 270A according to the present embodiment includes a combination counter control unit 276, in addition to the units in the learning process unit 270 according to the second embodiment. The combination counter control unit 276 controls the counters included in the combination-corresponding counter group 290.

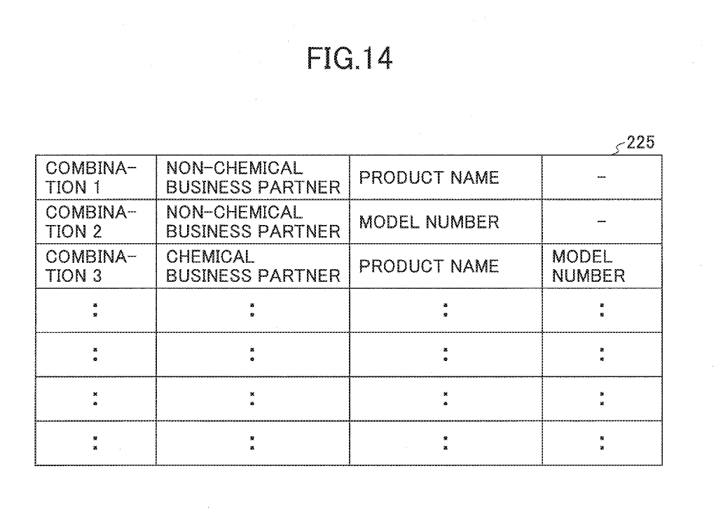

In the following, referring to FIG. 14, a description is given of the combination pattern database 225 according to the present embodiment. FIG. 14 is a diagram illustrating an example of a combination pattern database.

In the combination pattern database 225 according to the present embodiment, combination 1 is a combination of a non-chemical business partner and a product name, and combination 2 is a combination of a non-chemical business partner and a model number.

In the combination pattern database 225 according to the present embodiment, the patterns of all combinations of items included in the chemical material determination database 210 are stored.

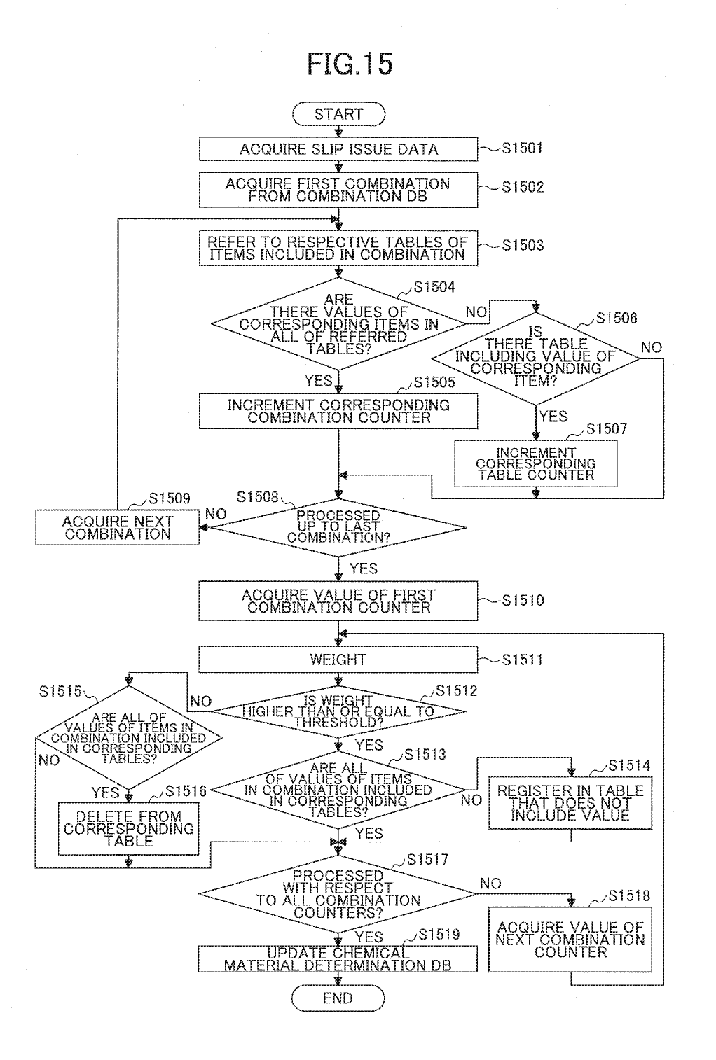

Next, referring to FIG. 15, a description is given of a process by the learning process unit 270A in the ordering device 200B according to the present embodiment.

FIG. 15 is a flowchart for describing a process by the learning process unit according to the third embodiment.

The slip issue data acquiring unit 271 according to the present embodiment acquires the slip issue data accepted by the slip issue accepting unit 231 (step S1501). Furthermore, the slip issue data acquiring unit 271 according to the present embodiment holds the number of the acquired slip issue data items.

Subsequently, the combination counter control unit 276 acquires the first combination from the combination pattern database 225 (step S1502).

Subsequently, the chemical material determination processing unit 240 refers to the tables in the chemical material determination database 210 corresponding to items included in the combination (step S1503). Subsequently, the chemical material determination processing unit 240 determines whether there are values in all of the tables corresponding to the items included in the combination, that match the values of the items included in the combination (step S1504).

In step S1504, when there are corresponding values in all of the tables, the counter control unit 272 increments the value of the counter corresponding to the acquired combination (step S1505), and proceeds to step S1508 described below.

In step S1504, when corresponding values are not included in all of the tables, the chemical material determination processing unit 240 determines whether there is a table including a value that matches the value of the item included in the combination (step S1506).

In step S1506, when there is no corresponding table, the process proceeds to step S1508 described below.

In step S1506, when there is a corresponding table, the counter control unit 272 increments the value of the counter corresponding to the corresponding table, included in the table-corresponding counter group 280 (step S1507).

Subsequently, the learning process unit 270A determines whether the processes from step S1503 through step S1507 have been performed for all of the combinations included in the combination pattern database 225 (step S1508).

In step S1508, when the processes have not been performed for all of the combinations, the combination counter control unit 276 acquires the next combination from the combination pattern database 225 (step S1509), and returns to step S1503.

In step S1508, when the processes have been performed for all of the combinations, the combination counter control unit 276 acquires the values of the counters corresponding to the first combination from the combination-corresponding counter group 290 (step S1510). Subsequently, the weighting unit 273 calculates the weight corresponding to the combination, based on the acquired values of counters (step S1511).

Subsequently, the level determining unit 274 determines whether the calculated weight is higher than or equal to a predetermined threshold (step S1512). In step S1512, when the calculated weight is higher than or equal to a predetermined threshold, the database updating unit 275 determines whether all of the values of items included in the combination are stored in the respective tables corresponding to the items in the combination (step S1513).

In step S1513, when all of the values of items are not stored in the respective tables, the database updating unit 275 stores the value of the item included in the combination, in the table that does not include the value of item (step S1514). In step S1513, when all of the values of items are stored in the respective tables, the process proceeds to step S1517 described below.

In step S1512, when the weight is less than the threshold, the database updating unit 275 determines whether all of the values of items included in the combination are stored in the respective tables corresponding to the items in the combination (step S1515).

In step S1515, when all of the values of items are stored in the respective tables, the database updating unit 275 deletes the values of the items included in the combination from the tables including values of the items (step S1516), and proceeds to step S1517 described below. In step S1515, when all of the values of items are not stored in the respective tables, the database updating unit 275 proceeds to step S1517 described below.

Subsequently, the database updating unit 275 determines whether the processes of steps S1511 through S1516 have been executed with respect to all of the counters included in the combination-corresponding counter group 290 (step S1517).

In step S1517, when the processes have not been executed, the combination counter control unit 276 acquires the values of the counters corresponding to the next combination that comes after the combination for which the values of counters have been acquired in the combination-corresponding counter group 290 (step S1518), and proceeds to step S1511. In step S1517, when the processes have been executed, the database updating unit 275 updates the chemical material determination database 210, and applies the values that have been registered to and deleted from the respective tables (step S1519).

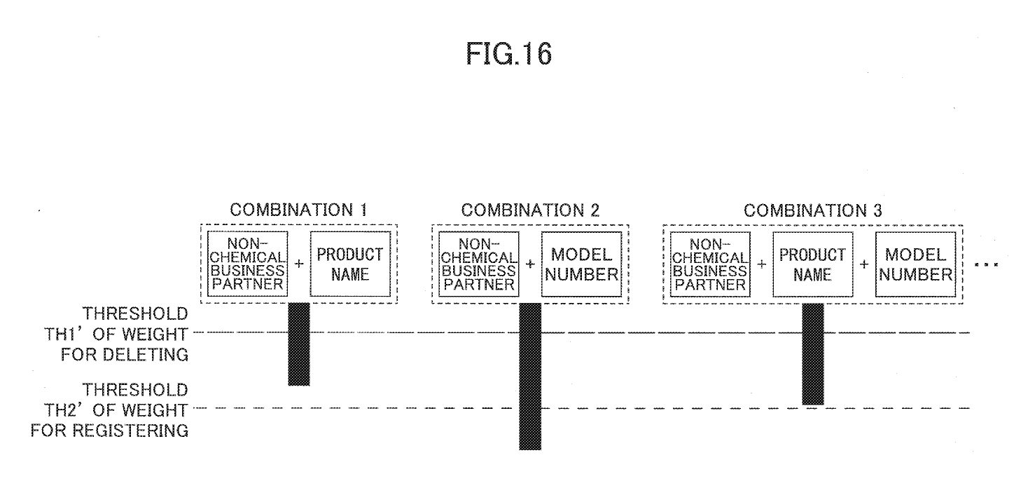

Next, referring to FIG. 16, a specific description is given of the process by the learning process unit 270A according to the present embodiment. FIG. 16 is a diagram for describing the process by the learning process unit according to the third embodiment.

Referring to FIG. 16, a description is given of an example in which the business partner name included in the slip issue data is aa chemicals, the product name included in the slip issue data is dimethylamine, and the model number included in the slip issue data is XB. Furthermore, in the example of FIG. 16, the threshold used for determining to delete a value of an item from the table is TH1′, and the threshold used for determining to register a value of an item to the table is TH2′.

In this case, in combination 1, the item “non-chemical business partner” and the item “product name” are associated with each other.

Therefore, when aa chemicals is included in the non-chemical business partner table 212 and dimethylamine is included in the product name table 214, the combination counter control unit 276 increments the counter corresponding to combination 1.

In the example of FIG. 16, aa chemicals is not included in the non-chemical business partner table 212 and dimethylamine is not included in the product name table 214, and therefore the combination counter control unit 276 does not increment the counter corresponding to combination 1.

Furthermore, the counter control unit 272 does not increment the counter corresponding to the non-chemical business partner table 212 or the counter corresponding to the product name table 214 included in the table-corresponding counter group 280.

Furthermore, in the example of FIG. 16, the weight of combination 1, which is calculated from the values of the counters corresponding to combination 1, is higher than or equal to the threshold TH1′ but less than the threshold TH2′. Therefore, in the example of FIG. 16, the database updating unit 275 does not register or delete “aa chemicals” and “dimethylamine” in the non-chemical business partner table 212 and the product name table 214, respectively.

Next, the combination counter control unit 276 increments the counter corresponding to combination 2, when aa chemicals is included in the non-chemical business partner table 212 and XB is included in the model number table 215. In this case also, similar to combination 1, the corresponding value (aa chemicals) is not included in the non-chemical business partner table 212, and therefore the counter corresponding to combination 2 is not incremented.

Here, the counter control unit 272 increments the value of the counter corresponding to the model number table 215 in the table-corresponding counter group 280.

Furthermore, in the example of FIG. 16, the weight of combination 2 calculated from the value of the counter corresponding to combination 2 is higher than or equal to the threshold TH2′. Furthermore, in the example of FIG. 16, “aa chemicals” is not included in the non-chemical business partner table 212. Therefore, in the example of FIG. 16, the database updating unit 275 registers “aa chemicals” in the non-chemical business partner table 212.

As described above, the learning process unit 270A according to the present embodiment controls the values of counters with respect to all of the combinations stored in the combination pattern database 225, and updates the chemical material determination database 210 according to the calculated weights based on the values of the counters.

Note that the present embodiment may be combined with the second embodiment. More specifically, for example, the ordering device 200A may be able to select between the value of the counter included in the table-corresponding counter group 280 or the value of the counter included in the combination-corresponding counter group 290, as the value of the counter used when calculating the weight.

Specifically, for example, the ordering device 200A may have a setting function of setting a priority level to the table-corresponding counter group 280 and the combination-corresponding counter group 290, and may use the value of the counter group for which a higher priority level is set, to calculate the weight.

As described above, in the present embodiment, the combinations of items included in the chemical material determination database 210 are used to update the chemical material determination database 210 used for determining whether the purchase target article is a chemical material.

Therefore, in the present embodiment, it is possible to increase the precision in the process of determining whether a purchase target article is a chemical material performed by the chemical material determination processing unit 240, and reduce the time and load taken in processes of the subsequent stages.

### Modified Examples

In the following, a description is given of a modified example of the first and second embodiments. In the ordering system 100 according to the first and second embodiments, the chemical material determination database 210 and the permission ID check database 220 are provided in the ordering device; however, these databases may be provided in devices other than the ordering device.

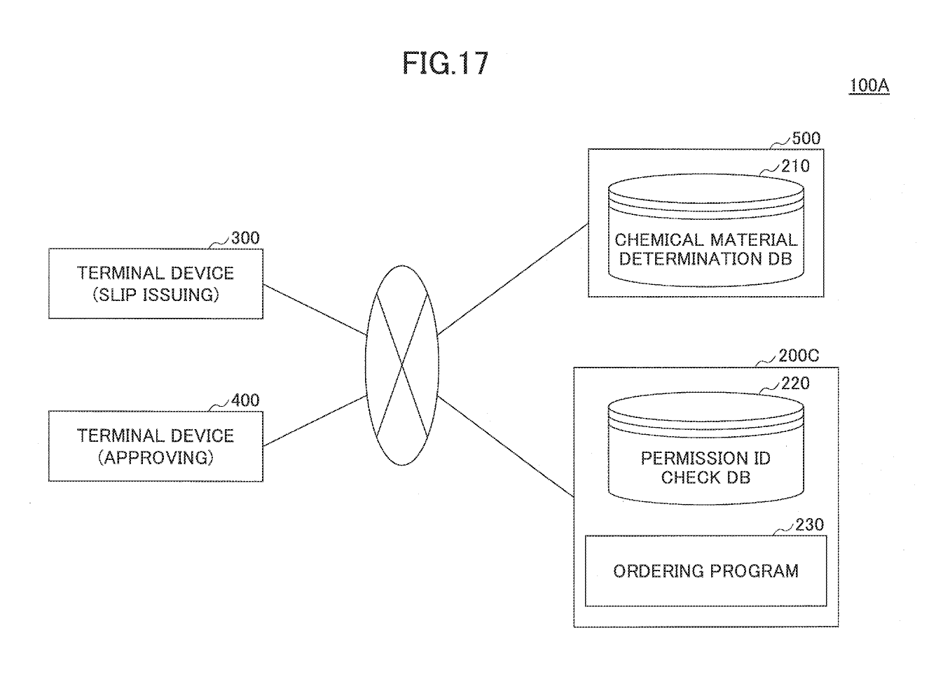

FIG. 17 is a diagram illustrating a first modified example of the ordering system.

In an ordering system 100A illustrated in FIG. 17, the chemical material determination database 210 is provided in an external server 500. In the ordering system 100A, an ordering device 200C includes the permission ID check database 220 and the ordering program 230. The ordering device 200C refers to the chemical material determination database 210 stored in the server 500, and executes the process of the ordering program 230.

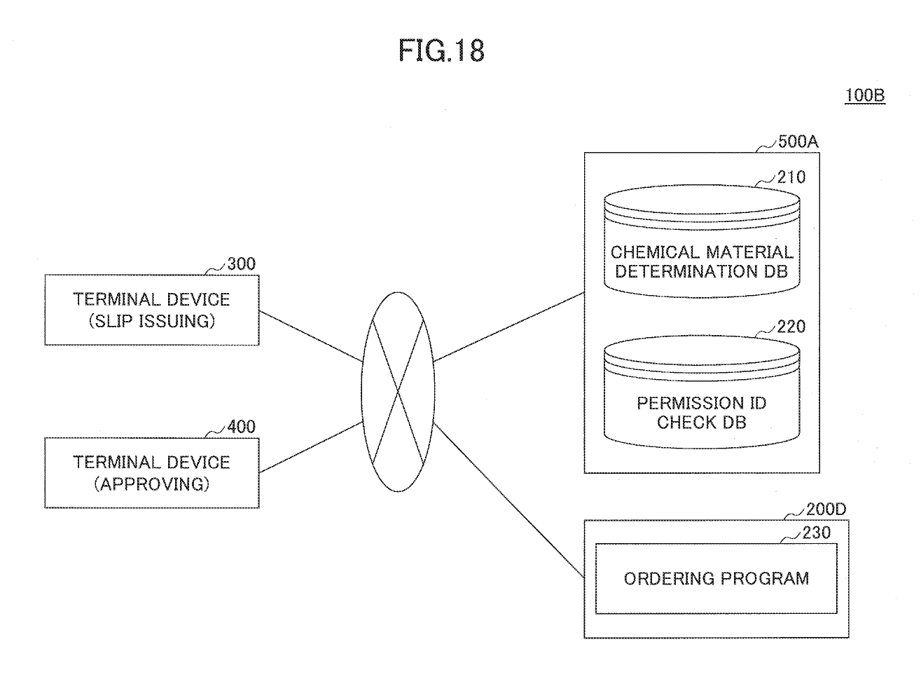

FIG. 18 is a diagram illustrating a second modified example of the ordering system.

In an ordering system 100B illustrated in FIG. 18, the chemical material determination database 210 and the permission ID check database 220 are provided in an external server 500A. In the ordering system 100B, an ordering device 200D includes the ordering program 230, and refers to the chemical material determination database 210 and the permission ID check database 220 stored in the server 500A to execute the process of the ordering program 230.

The disclosed technology is not limited to the embodiments specifically disclosed herein, and variations and modifications may be made without departing from the scope of the present invention.

An ordering person is caused to purchase a chemical material satisfying purchase conditions.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium storing an ordering program that causes a computer to execute a process, the process comprising:
determining whether an article is a chemical material by using slip issue data that is input when ordering the article;
checking whether the slip issue data includes permission identification information indicating that the article has been allowed to be ordered, when the article is determined to be the chemical material; and
making an approval request to approve of ordering the article according to a result of the checking of the slip issue data.

2. The non-transitory computer-readable recording medium according to claim 1, wherein the determining includes referring to a database storing at least a plurality of items included in the slip issue data and keywords corresponding to the plurality of items, and determining whether the slip issue data includes a keyword that matches any of the keywords stored in the database.

3. The non-transitory computer-readable recording medium according to claim 2, the process further comprising:
determining whether the slip issue data includes a keyword that matches any of the keywords corresponding to the plurality of items, for each of the plurality of items stored in the database; and
updating the database according to a result of the determining of whether the slip issue data includes a matching keyword.

4. The non-transitory computer-readable recording medium according to claim 3, wherein
the updating includes counting up a counter among a plurality of counters corresponding to the plurality of items, when the slip issue data includes a keyword that that matches any of the keywords stored in the database, the counted up counter corresponding to one of the plurality of items corresponding to the matching keyword,
calculating, for each of the plurality of items, a weight used for determining whether to update each of the keywords corresponding to the plurality of items, the weight being calculated by using a value of each of the plurality of counters corresponding to the plurality of items, and
updating one of the keywords corresponding to one of the plurality of items, when the weight of the one of the plurality of items corresponding to the one of the keywords is higher than or equal to a predetermined threshold.

5. The non-transitory computer-readable recording medium according to claim 4, wherein
an upper limit and a lower limit of the weight are set, and
when the calculated weight is higher than or equal to the upper limit or less than or equal to the lower limit, the upper limit or the lower limit is set as the weight.

6. The non-transitory computer-readable recording medium according to claim 2, further comprising:
referring to a combination database storing a combination of the plurality of items, and determining whether the slip issue data includes keywords that match keywords corresponding to the plurality of items included in the combination; and
updating the database according to a result of the determining of whether the slip issue data includes matching keywords.

7. The non-transitory computer-readable recording medium according to claim 6, wherein
the updating includes counting up a value of a combination counter corresponding to the combination, when the slip issue data includes keywords that match all of the keywords corresponding to the plurality of items included in the combination,
calculating, for each of the combinations, a weight used for determining whether to update each of the keywords corresponding to the plurality of items included in the combination, the weight being calculated by using the value of the combination counter, and
updating the keywords corresponding to the plurality of items in the combination, when the weight of the combination is higher than or equal to a predetermined threshold.

8. An ordering device comprising:
a processor configured to execute a process including
determining whether an article is a chemical material by using slip issue data that is input when ordering the article,
checking whether the slip issue data includes permission identification information indicating that the article has been allowed to be ordered, when the article is determined to be the chemical material, and
making an approval request to approve of ordering the article according to a result of the checking of the slip issue data.

9. An ordering method executed by a computer, the ordering method comprising:
determining whether an article is a chemical material by using slip issue data that is input when ordering the article;
checking whether the slip issue data includes permission identification information indicating that the article has been allowed to be ordered, when the article is determined to be the chemical material; and
making an approval request to approve of ordering the article according to a result of the checking of the slip issue data.
